(19) United States
(12) Patent Application Publication
(10) Pub. No.: US 2021/0330076 A1
(43) Pub. Date: Oct. 28, 2021

(54) SANITIZATION STATION KIT

(71) Applicant: Todd Noe, Del Mar, CA (US)

(72) Inventor: Todd Noe, Del Mar, CA (US)

(21) Appl. No.: 17/225,989

(22) Filed: Apr. 8, 2021

Related U.S. Application Data
(60) Provisional application No. 63/015,544, filed on Apr. 25, 2020.

(51) Int. Cl. A47B 47/00; B65F 1/14; A47K 5/12

(52) U.S. Cl. CPC A47B 47/0075; B65F 1/1426; A47K 5/12; A47B 2230/0018; A47B 2220/0027; A47B 2220/0058; A47K 2005/1218

(57) ABSTRACT

The invention herein disclosed is a sanitization station kit that comprises sheets of sheet metal components, pre-assembly, that supports minimal shipping volume; and upon delivery at a use site, the panels may be prepared and assembled using only a screw driver.

### TECHNICAL FIELD

The invention is a system for storing, displaying and dispensing items used for protecting against pathogen infection.

### BACKGROUND OF INVENTION

In late 2019 and into 2020 the world was hit by a corona-virus pathogen causing widespread illness and death. It was found that the two primary ways that the virus was passed on were touching a surface on which the virus was present and then touching one's nose, eye or mouth; and by inhaling shed virus through the nose or mouth. Steps were taken to help prevent rapid virus infection spread by proscribing that people keep at least six feet of distance from one another, and that plasticized gloves be used when picking up possibly infected items, and that face masks be used.

Worldwide, people were ordered to shelter at home, non-essential businesses were closed, and many people adopted the safety measures proscribed by authorities.

As the pandemic has run its course, and new infection and death rates have diminished over some predetermined period of time, cities, states and countries are gradually removing shelter-at-home requirements.

As people once again begin working in offices and shopping in stores, it will be necessary to ensure that people have easy access to methods and items known to reduce infection spread. Sanitization stations that provide safe access to and disposal of such sanitization items will be widespread throughout offices and stores to ensure that a relaxing of stay-at-home requirements does not pose significant risk of a second wave of pandemic.

Such sanitization stations will need to be produced in great numbers and shipped while efforts are made to reduce costs of production and shipping.

### BRIEF DESCRIPTION OF INVENTION

The invention herein disclosed and claimed is a sanitization station kit that consists of flat, metallic panels, that can be shipped in flat packages, and easily assembled once delivered to the intended use site. Some panels have partial cuts allowing portions to be easily bent such that upon arrival and unpacking, each sanitization station kit can be assembled quickly, using only a screw driver, in a short amount of time. The station surrounds a standard waste disposal receptacle which can be inserted and removed in seconds. It also includes dispensers for sanitization items such as gloves, hand sanitizers, masks, plastic bags, and the like.

### BRIEF DESCRIPTION OF DRAWINGS

FIG. 1 shows the six, constituent components, in flattened form

FIG. 2 illustrates how a flat panel can be bent to create a three-dimensional component.

FIG. 3 illustrates how the components can be combined

FIG. 4 illustrates an exemplary sequence of assembly steps involving the components from FIG. 1.

FIG. 5 shows a fully assembled sanitization station with a waste-receptacle inside below its cutout and a removable supplies container.

### DETAILED DESCRIPTION OF INVENTION

In the face of existing and future pandemics, it is critical that people have easy access to sanitization items known to reduce the spread of virus infection. Such items as: waste disposal, gloves, masks, hand sanitizer and the like need to be located near to one another, and in several different locations in which it is expected that numbers of people will congregate.

The invention herein disclosed and claimed is a sanitization station kit, which when assembled provides that single source of sanitization items, but when shipped or relocated, can be shipped as flat, panel components that take up minimal amount of volume and thereby cost less to ship.

By reducing the number of components to six, metallic sheets, the delivered sanitization station kit can be unpacked and assembled in a relatively short amount of time using only a screw driver.

Once assembled, the sanitization station may enclose a standard-sized waste receptacle and provides at least one dispensing location from which sanitization items can be easily accessed.

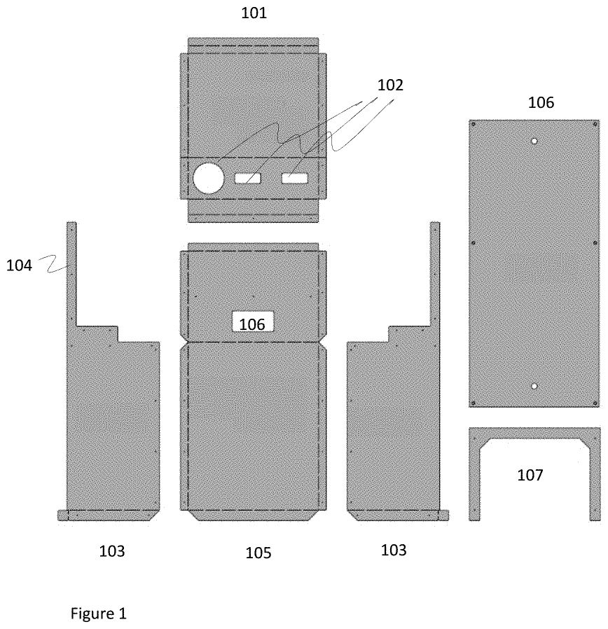

As shown in FIG. 1, the sanitization station kit comprises at least one top panel (101) having at least one top-panel cut-out (102) that can support an item-dispensing container; two side panels (103) with an extended portion (104); a front panel (105) with a front-panel cut-out (106); a back panel (106); and a base panel (107).

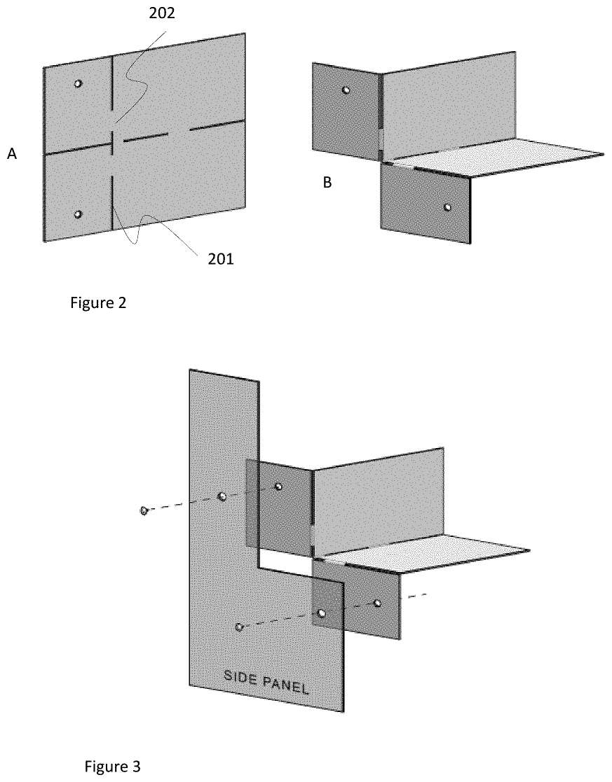

A shown in FIG. 2, the top, side, and front panels have partially cut portions (201) where remaining material (202) performs as a hinging device that facilitates bending at right angles.

Once bent, the panels may be joined using sheet-metal screws in pre-drilled holes as illustrated in FIG. 3.

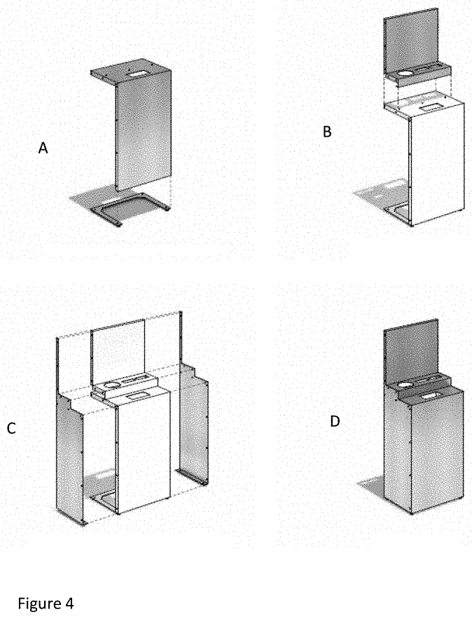

An exemplary assembly sequence is illustrated in FIG. 4A-4D. In 4A, the front panel (101), with its upper portion bent, as shown, is attached to the base panel (107). In 4B, the top panel (101), bent as shown is placed atop the horizontal portion of the front panel (105). In 4C, the side panels (103) are placed on both sides of the current assembly; and in 4D the side panels (103) are screwed in place using sheet-metal screws in the pre-drilled holes. The back panel (not shown) has magnetic fixtures on its four corners, and is magnetically coupled to the rear of the assembly. The easily-removable back panel allows access to the interior of the sanitization station for inserting or removing the waste receptacle and for storing sanitization items.

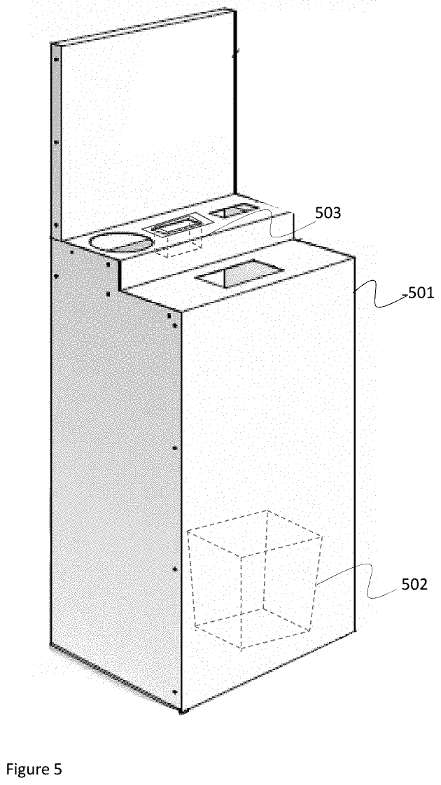

FIG. 5 is another view of the assembled sanitization station (501) showing an inside, removable waste receptacle located (502) below the front-panel cut-out and a removable supplies container (503) that inserted into a top-panel cutout and remains fixed in position by virtue of its extended top edges.

The panels are sheet metal and may be made of any sheet metal such as aluminum, steel, stainless steel or metal alloys.

All panels may be provided with a protective coating to provide corrosion resistance.

The horizontal portion of the top panel may also have an additional surface coating that could shorten the viability of any pathogens that may be deposited upon it.

The dimensions of the various panels are not critical but must be complementary. That is, the dimensions of the side panels, front panel, back panel and base panel must complement the width and depth dimensions of the top panel. One dimension that is proscribed by ADA regulations is the height of the top panel's horizontal portion above the base.

All drawings and descriptions are meant to be exemplary and should not be read as limiting the scope of the invention. For example, there may be one or more cut-outs in the horizontal portion of the top panel. A dispenser need not be fixed to the horizontal portion of the top panel and may be located on the vertical portion of the top panel. The rear panel need not be the way to access the trash receptacle and stored items; a door may be included in a side panel, front panel or rear panel.

What is claimed is a sanitization station kit comprising:

1. A system comprising a top panel, two identical side panels, a front panel, a back panel and a base panel;
said top, side, front, back and base panels are essentially planar;
said top, side and front panels have partially cut seams;
said seams are operative to allow bending said essentially planar panels to form surfaces on said planar panels that are essentially perpendicular to said planar panel;
said surfaces that are essentially perpendicular to said planar panel are operative to allow said panels to be securely joined to form a three-dimensional enclosure; and
said top panel has at least one top-panel cut-out and said front panel has at least one front-panel cutout.

2. A system as in claim 1 further comprising:
said top, side, front, back and base panels have holes in said essentially planar panels such that, when bent at said seams to form said essentially perpendicular surfaces, said holes are aligned such that said panels may be securely joined using sheet metal screws.

3. A system as in claim 1 further comprising:
said at least one front-panel cutout will, when bent at said seam, be on a top horizontal surface;
said at least one front-panel cutout is operative to allow a removable waste receptacle located inside said three-dimensional enclosure, and located below said at least one front-panel cutout, to receive objects inserted in said cutout.

4. A system as in claim 1 further comprising:
said at least one top-panel cutout is operative to allow a removable supplies container to be inserted into said top-panel cutout wherein said removable supplies container fits securely into said top-panel cutout.

5. A system as in claim 1 further comprising:
said base panel has frictional rubber feet at the corners of its rectangular periphery;
said frictional rubber feet make contact with surface upon which said three-dimensional enclosure is resting.

6. A system as in claim 1 further comprising:
said back panel has magnetic fixtures attached to the corners of its rectangular periphery such that it may be easily secured in place or removed to allow access to items inside said three-dimensional enclosure.
